(19) United States
(12) Patent Application Publication
(10) Pub. No.: US 2005/0060260 A1
(43) Pub. Date: Mar. 17, 2005

(54) Payment system, payment apparatus, and payment program storage medium

(75) Inventors: Takahiro Masuda, Kawasaki (JP); Yoshifusa Togawa, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/972,694

(22) Filed: Oct. 26, 2004

Related U.S. Application Data
(63) Continuation of application No. PCT/JP02/07346, filed on Jul. 19, 2002.

(51) Int. Cl. G06F 17/60

(52) U.S. Cl. 705/40

(57) ABSTRACT

A payment system realizes payment with high flexibility, and includes: a transaction designation section designating a transaction to be settled depending on an operation; a payment way designation section capable of designating a plurality of payment way for each transaction, which designates payment way for making payment for a transaction depending on an operation; and a payment share section allowing a plurality of payment way designated by the payment way designation section to share payment for a transaction designated by the transaction designation section.

### TECHNICAL FIELD

The present invention relates to a payment system and a payment apparatus that make payment of a transaction using payment way such as a credit card, a debit card, electronic money, etc., a payment program causing a computer to perform as the payment system and the payment apparatus, and a payment program storage medium storing the payment program.

### BACKGROUND ART

Currently, payments are widely made using various payment way such as a credit card, a debit card, electronic money, etc. without using cash in online shopping and normal shopping. A purchaser who requests to make payment without using cash as mentioned above selects desired payment way to be used for each purchase from among the payment way registered in advance. Then, the purchase amount is transferred from the account corresponding to the payment way in a lump sum or by installments. The above-mentioned payment system is disclosed by Japanese Patent Laid-Open No. 60-204072.

However, in the above-mentioned payment, for example, the following cases can occur.

There is the balance of ¥500,000 in the account 1 in the bank A, and the balance of ¥300,000 in the account 2 of the bank B. A debit card contract is assumed to be set for each account. Under the condition, when a user requests to buy goods for ¥600,000, the amount of ¥600,000 exceeds the balance of either of the accounts 1 and 2. Therefore, a deficit balance occurs in each account. As a result, although the total amount of the accounts 1 and 2 is larger than the purchase amount of the goods to be purchased, the goods cannot be purchased using the debit card in this case. That is, although the user can actually pay the amount, the goods cannot be purchased.

Furthermore, when a user is purchasing goods of a relatively large amount, he or she may request to make payment by a transfer from the account using a debit card as much as possible, and request to pay the deficit by installments using a credit card so that the total amount can be successfully paid. However, there is no system to realize such a paying method.

Furthermore, there are not a few families that each account is used depending on the payment item, for example, “the payment for foods is to be transferred from the account in the bank A, and all other miscellaneous expenses from the account in the bank B”, etc. However, when several types of goods are purchased in online shopping, the payment procedure cannot be followed for each of a large number of payment items or it is a complicated operation to first make payment using one payment way, and then perform later the transfer and deposit to make adjustments among several accounts.

Additionally, to efficiently obtain a service point assigned depending on the balance of an account and paid amount as a part of service of the related bank and credit company, etc. or to address the pay off and so on, deposits and savings can be divided into multiple accounts and financial institutions. In this case, when payment is made using one of the divided deposits and savings, it is necessary to transfer money among the accounts and financial institutions to later adjust the balances, thereby requiring complicated operations.

### DISCLOSURE OF THE INVENTION

The present invention has been developed to solve the above-mentioned problems, and aims at providing a payment system and a payment apparatus capable of providing increased flexibility.

To attain the above-mentioned objects, the payment system according to the present invention includes:
a transaction designation section designating a transaction to be settled depending on an operation;
a payment way designation section which designates payment way for making payment for a transaction depending on an operation and which is capable of designating multiple payment way for each transaction; and
a payment share section allowing multiple payment way designated by the payment way designation section to share payment for a transaction designated by the transaction designation section.

Since the payment system of the present invention includes a payment way designation section capable of designating multiple payment way for each transaction and a payment share section capable of allowing the multiple payment way to share the payment for each transaction, the payment using the multiple payment way can be made, thereby increasing the flexibility in payment.

The payment system according to the present invention may include the payment share section allowing the multiple payment way to share the payment based on setting in which at least one of an amount and a rate is set in each of the multiple payment way.

Otherwise, the payment system according to the present invention may include a rule storage section storing a rule for dividing a payment into multiple payment way, wherein the payment share section divides a payment according to the rule stored in the rule storage section, and the divided payment is shared among the multiple payment way.

According to the payment system in which an amount or a rate is set, a purchaser, etc. can freely set the amount or the rate to be shared among multiple payment way. The payment share section may be directly operated by a purchaser to set an amount, etc. Alternatively, it may be indirectly set by receiving a set value set by a purchaser, etc.

Furthermore, according to the payment system for sharing payment based on the rule, a purchaser, etc. can be free of setting the amount for each transaction in detail. Additionally, by an operator of the payment system preparing a convenient rule, the operation to be performed by the purchaser, etc. can be omitted, thereby increasing the convenience for the purchaser, etc.

In the case of the payment system for dividing the payment according to rules, it is desired that the rule storage section stores multiple rules, wherein the payment share section is assigned one of the rules stored in the rule storage section, shares the payment according to the designated rule, and allows multiple payment way to share the assigned payment.

With the above-mentioned payment system, multiple rules presented depending on some payment patterns reduces the required operations and increases the convenience when payment is made.

It is also preferable that the payment system according to the present invention includes a simulation section simulating a payment result of a transaction for payment way designated by the payment way designation section. In this case, it is desired that the simulation section assign a priority to multiple payment way based on the payment result obtained from the simulation.

The payment system including the simulation section can present a purchaser, etc. with a payment result such as a final and total payment amount, the balance, an acquired service point, etc., and can present the priority based on the payment result. Therefore, the purchaser, etc. can easily determine the desired share for the purchaser, etc. by referring to the payment result and the priority.

To attain the above-mentioned object, the payment apparatus according to the present invention includes:
a transaction designation reception section receiving designation of a transaction over a communications network;
a payment way designation reception section which receives designation of payment way for making payment for a transaction via a communications network and which is capable of receiving designation of multiple payment way for one transaction; and
a payment share section allowing multiple payment way whose designation is received by the payment way designation reception section to share the payment of the transaction whose designation is received by the transaction designation reception section.

The payment apparatus according to the present invention enables a payment of high-level flexibility using multiple payment way, and easily realizes the payment system according to the present invention by a combination with a communications network.

To attain the above-mentioned object, the payment program according to the present invention includes:
a transaction designation reception section receiving designation of a transaction over a communications network;
a payment way designation reception section which receives designation of payment way making payment for a transaction over a communications network and which is capable of receiving designation of multiple payment way for one transaction; and
a payment share section allowing multiple payment way whose designation is received by the payment way designation reception section to share the payment of the transaction whose designation is received by the transaction designation reception section.

To attain the above-mentioned object, the payment program storage medium according to the present invention stores a payment program including:
a transaction designation reception section receiving designation of a transaction over a communications network;
a payment way designation reception section which receives designation of payment way for making payment for a transaction over a communications network and which is capable of receiving designation of multiple payment way for one transaction; and
a payment share section allowing multiple payment way whose designation is received by the payment way designation reception section to share the payment of the transaction whose designation is received by the transaction designation reception section.

By a combination use with a computer system and a communications network, the payment program and the payment program storage medium of the present invention can easily realize the payment system and the payment apparatus according to the present invention.

Only the basic aspect of the payment apparatus and the payment program according to the present invention is described here to avoid overlapping explanation. That is, the payment apparatus and the payment program according to the present invention include not only the above-mentioned basic aspect, but also various aspects corresponding to the aspects of the above-mentioned payment system.

The payment system and the payment apparatus according to the present invention and the above-mentioned payment program are assigned the same names such as a payment share section as the name of a component. However, the payment program refers to the software having the above-mentioned functions, and the payment system and the payment apparatus refer to the hardware having the above-mentioned functions.

The computer system incorporating a payment program according to the present invention can be composed of a computer and peripheral devices, or include multiple computers.

Furthermore, the component such as a payment share section forming the payment program of the present invention can have: the function of one component shared by a program portion; the function of one component shared by multiple program portions; and the function of multiple components shared by a program portion. These components can perform the functions, or allow other program and program portions incorporated into a computer to perform the functions.

As explained above, according to the present invention, a payment system and a payment apparatus having enhanced flexibility can be obtained.

### BRIEF DESCRIPTION OF THE DRAWINGS

FIG. 1 is a schematic chart showing an example of a computer network realizing an embodiment of the present invention;

FIG. 2 shows an embodiment of the payment program according to the present invention;

FIG. 3 is a block diagram of the functions of an embodiment of the payment system and the payment apparatus according to the present invention;

FIG. 4 is a flowchart of the procedure of registering payment way;

FIG. 5 shows the registration information of the payment way;

FIG. 6 is a flowchart of the procedure for payment;

FIG. 7 is a flowchart of the operation of obtaining information and setting an initial share value;

FIG. 8 is a flowchart indicating the procedure of obtaining the information about each financial institution;

FIG. 9 shows item information;

FIG. 10 shows obtained information;

FIG. 11 shows a designation screen;

FIG. 12 shows a result display screen;

FIG. 13 shows the second embodiment of the payment program according to the present invention;

FIG. 14 is a block diagram of the function according to the second embodiment of the payment system and the payment apparatus of the present invention;

FIG. 15 is a flowchart of the procedure for payment according to the second embodiment of the present invention;

FIG. 16 shows the share rule selection screen;

FIG. 17 shows the rule data of the share rule based on the payment day;

FIG. 18 is a flowchart of the procedure of setting a share rule based on a payment day;

FIG. 19 shows the rule data of the share rule depending on the types of goods; and

FIG. 20 is a flowchart of the procedure of sharing the payment amount according to the share rule for the share depending on the type of goods.

### BEST MODE FOR CARRYING OUT THE INVENTION

The embodiments of the present invention are explained below.

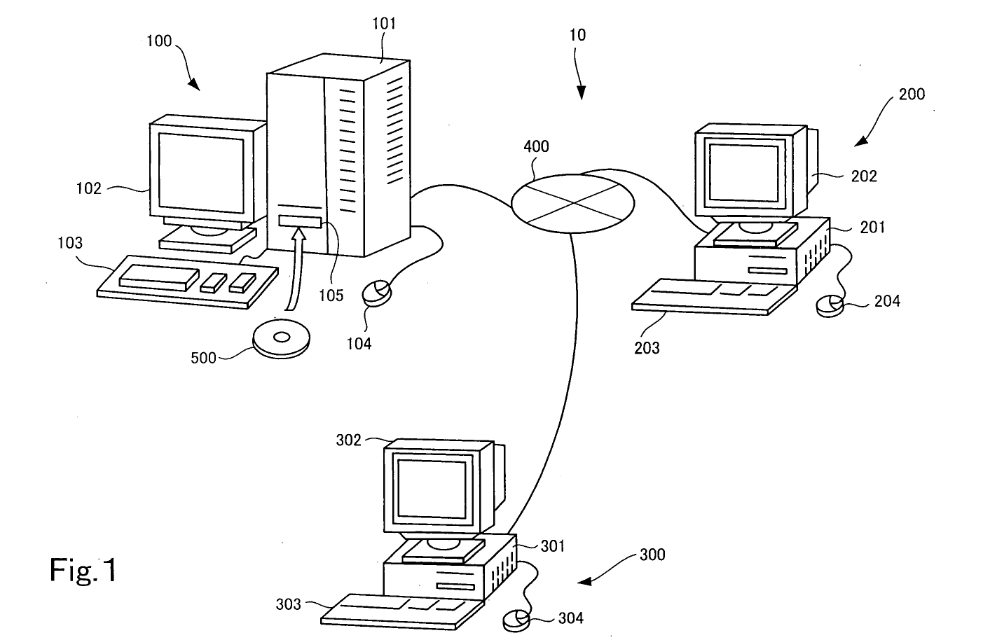

FIG. 1 is a schematic chart showing an example of a computer network realizing an embodiment of the present invention.

FIG. 1 shows a computer network 10 in which a computer operating as what is called a server machine 100 and two computers operating as what is called client machines 200 and 300 are interconnected over a communications network 400.

The communications network 400 is connected to the Internet, etc. In the present embodiment, the computer network 10 functions as a system for executing payment for a transaction in the Internet shopping using a site operated by a credit card company, a bank, etc.

The server machine 100 and the client machines 200 and 300 have bodies 101, 201, and 301 each having a CPU, a main storage device, a hard disk, a communications board, etc.; displays 102, 202, and 302 for displaying an image and a character string on display screens 102a, 202a, and 302a according to an instruction of the bodies 101, 201 and 301; keyboards 103, 203, and 303 for inputting an instruction of a user to the computers 100, 200, and 300; and mice 104, 204, and 304 for inputting an instruction depending on the icon, etc. displayed in the position when an arbitrary position is designated on the display screens 102a, 202a, and 302a.

The body 101 of the server machine 100 has a CD-ROM slot 105 for insertion of a CD-ROM 500 in which a CD-ROM drive for driving and accessing the CD-ROM 500 inserted through the CD-ROM slot 105 is also incorporated.

With the configuration, the CD-ROM 500 stores the payment program according to the present invention, which is inserted into the body 101 through the CD-ROM slot 105. The payment program stored in the CD-ROM 500 is installed by the CD-ROM drive in the hard disk of the server machine 100. When the payment program installed in the hard disk of the server machine 100 is activated, the server machine 100 operates as an embodiment of the payment apparatus according to the present invention.

Therefore, the CD-ROM 500 storing the payment program corresponds to an embodiment of the payment program storage medium according to the present invention.

The payment program stored in the CD-ROM 500 is installed in the hard disk of the server machine 100 as described above, but the hard disk in which the payment program is installed also corresponds to an embodiment of the payment program storage medium of the present invention.

Furthermore, when the payment program is downloaded into another storage medium such as a flexible disk, etc., the storage medium such as the flexible disk, etc. storing the downloaded payment program also corresponds to an embodiment of the payment program storage medium according to the present invention. The payment program storage medium according to the present invention is not limited to the examples indicated here, but can be a DVD, a compact disk, a card- or stick-shaped small medium. When the payment program storage medium according to the present invention is such storage media, a computer which executes the payment program according to the present invention has a drive which accesses the storage media.

By the server machine 100 operating as an embodiment of the payment apparatus according to the present invention, the computer network 10 having the server machine 100 and the client machines 200 and 300 is operated as an embodiment of the payment system according to the present invention.

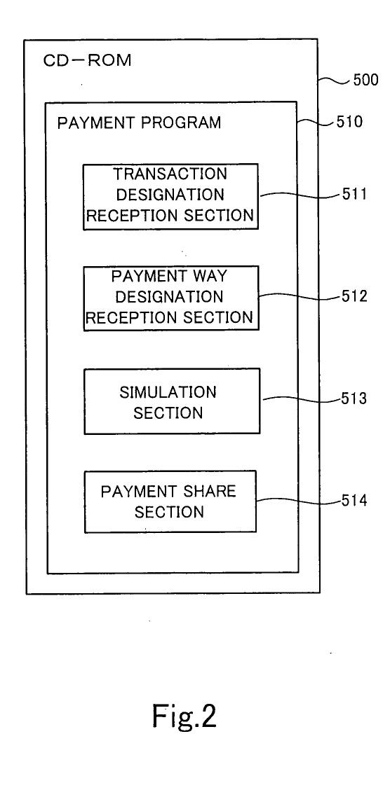

FIG. 2 shows the first embodiment of the payment program according to the present invention. In FIG. 2, a payment program 510 is stored in the CD-ROM 500.

The payment program 510 is executed in the server machine 100 shown in FIG. 1, operates the server machine 100 as the first embodiment of the payment apparatus according to the present invention, and has a transaction designation reception section 511, a payment way designation reception section 512, a simulation section 513, and a payment share section 514. Each element of the payment program 510 will be described later.

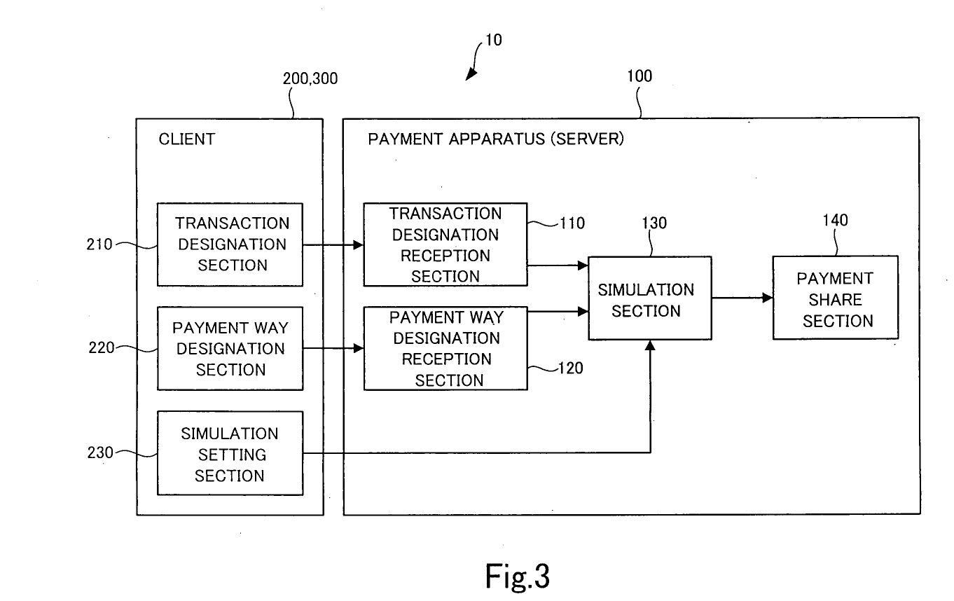

FIG. 3 is a block diagram of the function of the first embodiment of the payment system and the payment apparatus according to the present invention.

Shown in the block diagram of the functions are the computer network 10, the server machine 100, and the client machines 200 and 300 shown in FIG. 1. However, the client machines 200 and 300 are represented by one machine.

In the server machine 100 shown in FIG. 3, the payment program 510 shown in FIG. 2 is installed and executed. Thus, the first embodiment of the payment apparatus of the present invention is configured on the server machine 100 and the first embodiment of the payment system of the present invention is configured on the computer network 10.

The first embodiment of the payment apparatus has a transaction designation reception section 110, a payment way designation reception section 120, a simulation section 130, and a payment share section 140. These transaction designation reception section 110, payment way designation reception section 120, simulation section 130, and payment share section 140 respectively correspond to the transaction designation reception section 511, the payment way designation reception section 512, the simulation section 513, and the payment share section 514 forming the payment program 510 shown in FIG. 2, but each element shown in FIG. 3 is configured by a combination of the hardware of the server machine 100 with the OS and the application program executed by the server machine 100 while each element of the payment program shown in FIG. 2 is configured by only the application program.

By the client machines 200 and 300 accessing the transaction designation reception section 110, the payment way designation reception section 120, and the simulation section 130, the client machines 200 and 300 operate as the terminal having a transaction designation section 210, a payment way designation section 220, and a simulation setting section 230.

By explaining each element of the payment system and the payment apparatus shown in FIG. 3, each element of the payment program 510 shown in FIG. 2 is explained together.

The outline of each element is explained first.

In the present embodiment, the client machines 200 and 300 are operated by a purchaser who purchases goods or services in the Internet shopping.

The transaction designation section 210 of the client machines 200 and 300 designates a transaction to be settled depending on the operation of a purchaser. In this example, goods and services to be purchased in the shopping mall over the Internet are designated as target to be settled.

Depending on the operation of a purchaser, the payment way designation section 220 of the client machines 200 and 300 designates payment way for making payment for a current transaction among multiple payment way such as a credit card, etc. registered in advance. Multiple payment way can be designated for one transaction.

The transaction designation reception section 110 and the payment way designation reception section 120 of the server machine 100 respectively receives the designation of a transaction by the transaction designation section 210 and the designation of payment way by the payment way designation section 220.

The simulation section 130 of the server machine 100 simulates a payment result about the transaction and the payment way whose designation have been received by the transaction designation reception section 110 and the payment way designation reception section 120, and the simulation setting section 230 of the client machines 200 and 300 sets the conditions of the simulation. As described later, according to the present embodiment, the simulation section 130 provides a reference value for a purchaser who determines the share of the payment.

The payment share section 140 of the server machine 100 shares the payment among multiple payment way based on the share determined by the purchaser by referring to the simulation by the simulation section 130.

The above-mentioned payment system and the payment apparatus can allow multiple payment way to share the payment for one transaction, thereby increasing the flexibility in payment.

Described below are the details of the operations of the payment system and the payment apparatus. In the following explanation, for a purpose of convenience of explanation the payment system and the payment apparatus are described as being operated directly by a seller of goods and services.

A purchaser (buyer) registers in advance the account of payment way, etc. which is possibly used in making payment in the payment apparatus and the payment system (seller). The registration can be performed before making payment or when a user follows the procedure of obtaining the membership for a shopping service.

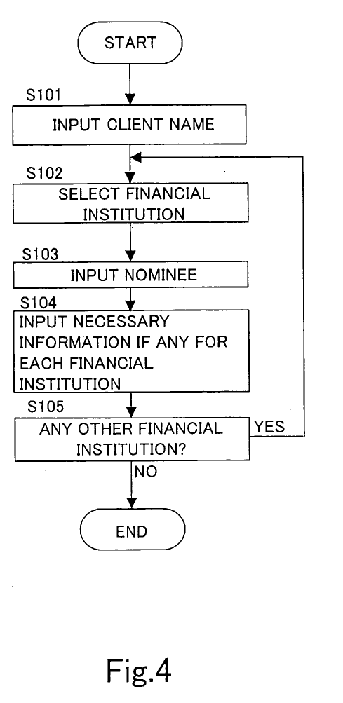

FIG. 4 is a flowchart showing the registration procedure of payment way.

In this registration procedure, the purchaser enters his or her name (step S101), selects a financial institution such as a credit card company, a bank, etc. for use as payment way (step S102), and inputs the nominee relating to the credit card company, the bank, etc. (step S103).

Furthermore, for each financial institution, the information is input when other information is required (step S104).

Finally, it is confirmed whether or not there is other payment way available as a financial institution (step S105). If there is any, control is returned to step S102, and the above-mentioned procedure is repeated. If not, the registration procedure terminates.

In the status in which an account has already been registered, the processes such as the addition, deletion, and change of a payment way can be performed in any period.

When the above-mentioned registration information about payment way is transmitted to the payment device, the payment device verifies the correctness of the registration information received from the “buying side” by accessing the site of a financial institution, and registers the correct registration information received from the “buying side” in the database managed by the payment way designation reception section 120 shown in FIG. 3. The incorrect information is requested to be corrected and registered again.

In the payment apparatus according to the present embodiment, the registration information about the payment way is stored in the following format.

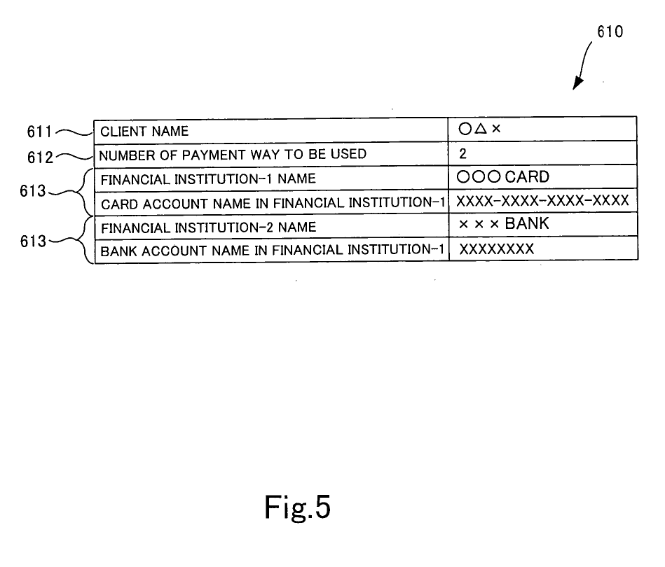

FIG. 5 shows the registration information about the payment way.

Registration information 610 includes a purchaser name 611 which is a client name and the number 612 of payment way. The same number of sets 613 of a financial institution name and an account as the number 612 of payment way are contained.

For example, the registration information 610 shown in FIG. 5 indicates the following meanings. That is, the client name is “◯Δ×”, and there are two payment way. The first payment way is “◯◯◯ card”. When the information about the payment way is obtained from the financial institution, an account of “××××-××××-××××-××××” is used. The second payment way is a “××× Bank”. When the information about the payment way is obtained from the financial institution, the account of “××××××××” is used.

The information registered in the above-mentioned format is managed by the payment way designation reception section 120 shown in FIG. 3. When a client who is a buyer is making payment, the information is referred to by the client who wants to know what payment way can be used.

Next, the seller (selling side) of goods and services provides goods information for a number of unspecified clients by publishing a sales page describing the information about goods for sale, etc. in the shopping mall over the Internet. Otherwise, a list of goods and services, etc. is presented to the “buying side” of a specific person using means such as mail, etc. The “buying side” determines the desired goods, etc. to be purchased in the goods or services provided by the “selling side”, calls the dedicated page presented in the transaction designation reception section 110 shown by the “selling side” in FIG. 3 using transaction designation section 210, and presents the desired goods, etc. to the “selling side”.

By the above-mentioned presentation, the transaction is designated and the procedure for the payment is started.

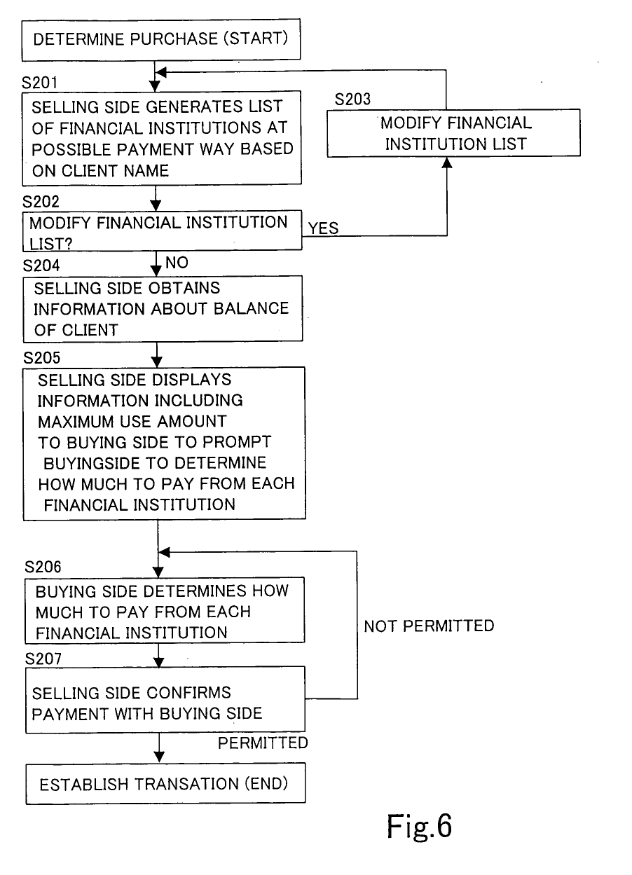

FIG. 6 is a flowchart showing the procedure for payment.

In the procedure shown in FIG. 6, first the “selling side” generates a list of financial institutions (payment way) available in making payment according to the registration information shown in FIG. 5, and presents it to the “buying side” (step S201). It is confirmed whether or not the “buying side” requests to add, delete, or change the payment way (step S202). If YES, the registration procedure shown in FIG. 4 and the procedure for a change, etc. are executed (step S203), and control is returned to step S201.

When the “buying side” does not request to add, delete, or change, etc. the payment way, the “selling side” obtains the information about the balance, the obtained maximum available amount, etc. relating to each financial institution (payment way) described in the list (step S204), the information and the purchase amount, etc. are presented to the “buying side” to prompt the “buying side” to determine the rate and amount to be shared by each payment way (step S205). At this time, the present embodiment tries to acquire convenience for the “buying side”. Therefore, the initial value for reference to the determination of a share is presented based on the result of the simulation by the simulation section 130 shown in FIG. 3. The details of the operations in the steps S204 and S205 will be further explained later.

The “buying side” determines the payment way to be used in the current payment and the share of the rate and the amount to be shared by each payment way (step S206) by referring to a balance of each financial institution, and the determined payment way and the share are designated and provided to the payment way designation reception section 120 by operating the payment way designation section 220 shown in FIG. 3. As designating method, for example, “¥◯◯ from the Bank A, ¥◯◯ from the Bank B” directly designates the amount, and “60% of the total amount from the Bank A, and the remaining 40% from the Bank B” designates the ratio to the total amount. In the present embodiment, for example, a method of designating a share rate is adopted. However, when a fractional amount is obtained by designating a share rate, an automatic adjustment is made such that a total amount can match the purchase amount. The details of the designating method will be described later.

Thus, according to the payment system of designating the payment way and the share, multiple payment way can share the amount and the rate freely set by the “buying side”.

Thus, after determining the share in step S206, the “selling side” finally confirms the payment share with the “buying side” (step S207). When the payment share is not permitted, control is returned to step S206, and the share is determined again. When the payment share is permitted, the “selling side” checks whether or not the payment share determined by the “buying side” is valid. If it is valid, the transaction is established at this time point, thereby terminating the procedure shown in FIG. 6.

Then, the “selling side” transmits to the “buying side” electronic mail as the confirmation of purchase, announcing the establishment of the transaction and the amount for the transaction, and delivers the goods requested by the “buying side”. The payment share section 140 shown in FIG. 3 accesses the site or dedicated network, etc. operated by the credit card company and the bank designated as payment way to set the transfer from the designated account, set the installments, etc. based on the determined share. There can be some days between the establishment of a transaction and the transfer of money. The delivery of goods, etc. can be performed after the lump-sum payment is made. When there is a deficit balance in the designated account in the actual transfer, the “selling side” sends electronic mail to the “buying side” as a notification and prompt the “buying side” to deposit money. When another account is set, the payment is made through the account. The detailed explanation of the process to be performed when there is a deficit balance will be given later.

The details of obtaining information and setting an initial share value in the above-mentioned steps S204 and S205 are described below.

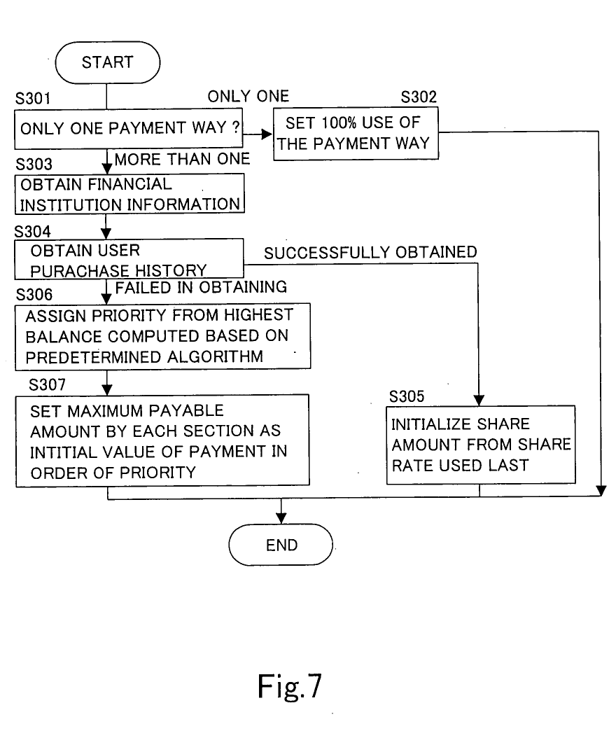

FIG. 7 is a flowchart showing the operation of obtaining information and setting an initial share value.

In the operation shown in FIG. 7, it is first determined whether or not the payment way registered in the above-mentioned registration procedure is only one (step S301). When it is the only one payment way, the share of 100% of the purchase amount is assigned to the payment way as the initial value, thereby terminating the process (step S302).

When multiple payment way are registered, the information about each financial institution registered as payment way is obtained (step S303). The details of the obtaining procedure of obtaining the information about each financial institution are explained below.

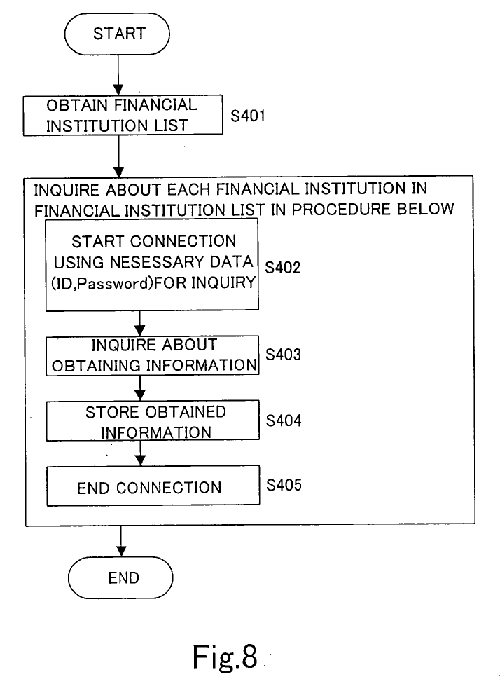

FIG. 8 is a flowchart showing the obtaining procedure of obtaining the information about each financial institution.

In this obtaining procedure, a list of financial institutions registered as payment way is obtained from the registration information shown in FIG. 5 (step S401), and the information about each financial institution described in the list is obtained in the following procedure. That is, access is gained over the Internet to the site, etc. of the financial institution using an ID and a password required to obtain information (step S402), and to inquire about the balance, the maximum use amount, the point service system, etc., thereby obtaining the information (step S403). The item of the information to be obtained is prepared in advance as item information in the format explained below.

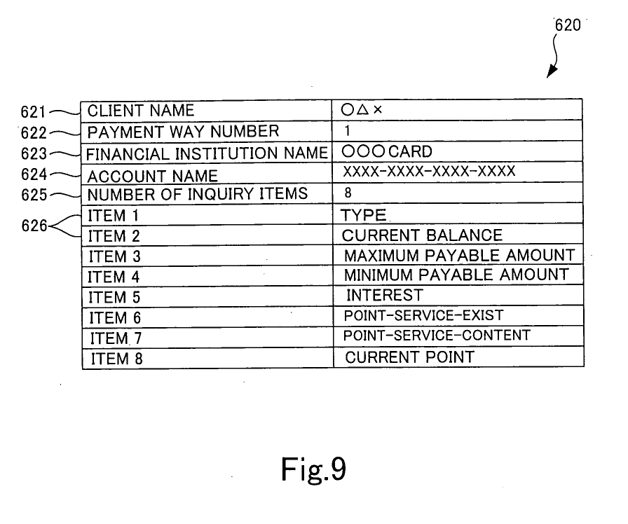

FIG. 9 shows the item information.

Item information 620 is prepared for each financial institution registered by each purchaser. The item information 620 has a purchaser name 621 of a client, a financial institution registration number 622 registered as payment way by a purchaser, a financial institution name 623, an account 624 for access to the site of the financial institution, and a number 625 of inquiry items. The item information 620 further has each inquiry item 626.

For example, the item information 620 shown in FIG. 9 indicates the following meanings. That is, the client name is “◯Δ×”, and the registration number of payment way (that is, a financial institution) is “1”. The name of the financial institution is “◯◯◯ card”. When an inquiry is issued, the account name of “××××-××××-××××-××××” is used. The number of items for inquiry is “8”. The first item is the “type” of financial institution. The second item is the “current balance”. The third item is the “maximum payable amount”. The fourth item is the “minimum payable amount”. The fifth item is the “interest”. The sixth item is “POINT_SERVICE_EXIST”, and is used in issuing an inquiry about the presence/absence of a point service system. The seventh item is “POINT_SERVICE_CONTENT” for inquiry about the breakdown of the point service system. The eighth item is the “current number of points”.

When information is obtained in step S403 in FIG. 8 according to the item information, the obtained information is stored in a predetermined recording position in the format described below.

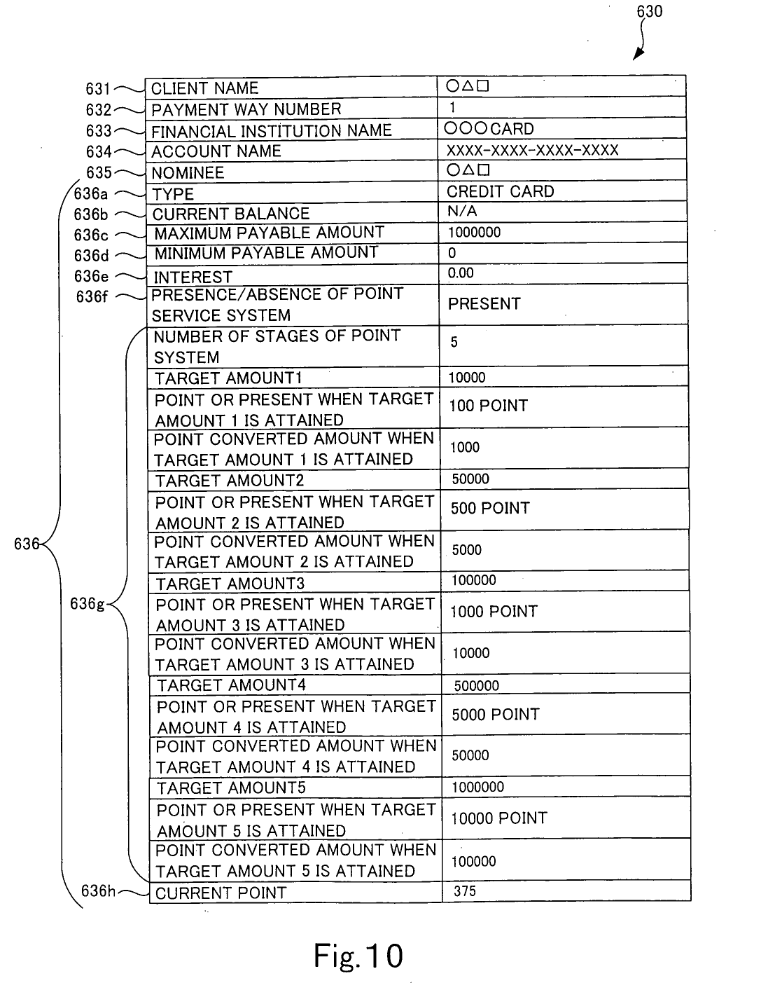

FIG. 10 shows the obtained information.

Obtained information 630 has, like the item information shown in FIG. 9, a client name 631, a registration number 632 of payment way, a financial institution name 633, and an account name 634. It also has a nominee 635 of the financial institution and information 636 obtained from the financial institution. In the example shown in FIG. 10, the information 636 obtained from a financial institution has a type 636a of a financial institution, a current balance 636b, a maximum payable amount 636c, a minimum payable amount 636d, an interest 636e, a presence/absence 636f of point service system, a breakdown 636g of point service system, and a current point 636h.

For example, the information 636 contained in the obtained information 630 shown in FIG. 10 has the following meaning. That is, the type of financial institution is “credit card”, the current balance is “N/A”, the maximum payment is “¥1,000,000”, a payment exceeding “¥0” can be made, and the interest is “0.00”. There is a point service system, and there are five levels of point services. When each target amount of ¥10,000, ¥50,000, ¥100,000, ¥500,000, and ¥1,000,000 is attained, each of the points 100, 500, 1000, 5000, and 10000 is assigned. The converted amounts after conversion from the point to the amount are ¥1,000, ¥5,000, ¥10,000, ¥50,000, and ¥100,000. The current points is “375” points.

When the obtained information is stored in step S404 shown in FIG. 8, the connection to the site of the financial institution is terminated (step S405), control is returned to step S402 so that the obtaining of the information is repeated for the next financial institution. The above-mentioned information is obtained relating to all registered financial institutions, the procedure of obtaining the information as shown in FIG. 8 is completed.

On the site of each financial institution, it is assumed that information is stored in the unified format by the HTML document, or in a unique format of each financial institution.

The unified format by the HTML document can be the format storing the item name and the contents of the item using the tag <table> of the HTML, etc. Since further details are not closely related to the present invention, the explanation is omitted here.

Back in FIG. 7, the explanation is continued as follows.

When the information about each financial institution is obtained in step S303 in the above-mentioned obtaining procedure, the purchase history of the current purchaser is obtained (step S304), the initial value indicating the purchase amount shared as the same share rate as that used in the latest purchase, thereby terminating the process (step S305).

When the purchase history of a purchaser cannot be obtained (failure in obtaining in step S304), the simulation explained below is performed by the simulation section 130 shown in FIG. 3, and a priority is assigned to the payment way (step S306).

In the simulation, the balance is computed after a predetermined period (for example, N months) that has been registered in advance has passed. The information such as the minimum balance of the account, the current interest of deposits and savings, the commission of the bank, the interest of loan set when it is established, the commission for a credit card, etc., the accumulated points, etc. is extracted from the obtained information as shown in FIG. 10, and the balance is simulated according to various information as the base.

In the above-mentioned simulation, when the current purchase amount is paid by one payment way, the computation of obtaining the balance after a predetermined period (N months) has passed from the current point is performed relating to each payment way. The higher the balance of payment way obtained in the simulation, the higher priority assigned.

When there is the balance higher than the purchase amount in the payment way in which no minus balance is permitted, calculation is performed, with the minus balance assumed to be obtained by adding an interest at a predetermined rate to the excess amount. As the rate of the interest, the interest of the loan is used when the purchaser has registered the available loan for the case in which a deficit balance occurs. If such a loan has not been registered, a mean value of the currently available loan interest is used. The mean value can be obtained by referring to each interest available in the loan systems of all financial institutions to which the payment system can refer to.

When there is a point service system based on the purchase amount, the balance, etc., the profit obtained from the point service system is counted in obtaining the total balance after converting the rate into the amount.

When the interest of the deposits and savings changes with the total amount of the payment as a part of the services of the bank, etc., for example, a correspondence table is prepared to display the total amount of payment for one month and the increment/decrement of the interest so that the balance can be computed with the interest applied with the increment/decrement every month from a predetermined day of a month.

With the above-mentioned simulation performed in step S306 and the priority assigned to the payment way in order from the highest total balance, the maximum payable amount in the payment way is assigned from the highest priority assigned, thus setting the initial value of the payment share (step S307), thereby terminating the process.

Thus, when the initial value is set based on the purchase history, the simulation, etc., the initial value is displayed with the list of payment way, etc. on the specified screen for designating the payment way and the share. The method of designating the payment way and the share is explained below.

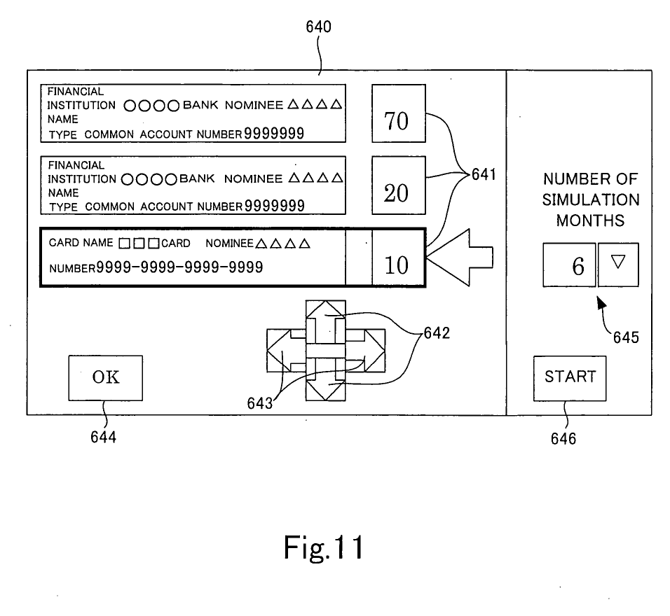

FIG. 11 shows the designation screen.

On a designation screen 640, share display fields 641 each corresponding to a registered payment way are provided. When the designation screen 640 is first displayed, the above-mentioned initial value is displayed in the share display column 641. The purchaser, etc. refers to the initial value, and easily determines the payment share. Furthermore, the name of the payment way is also displayed with each share display field 641.

On the designation screen 640, a payment way selection button 642 and a share change button 643 are provided. When the payment way selection button 642 is clicked, the selection frame indicated by an arrow moves up and down to another payment way. When the share change button 643 is clicked, the share to the payment way selected by the selection frame is increased/decreased. The purchaser, etc. can click the payment way selection button 642 and the share change button 643 to designate the payment way and the share for use in the payment for the current transaction. When the selection and adjustment are completed for the payment way and share, and the purchaser determines that the payment can be made with the payment way and the share, an OK button 644 can be clicked to transmit the determination contents to the payment share section 140, and then the payment is made based on the determination contents.

According to the present embodiment, the function as the simulation setting section 230 is incorporated into the designation screen 640, and the condition of the balance simulation similar to the above-mentioned simulation can be set to the simulation section 130. That is, the share displayed on the share display field 641 is changed by the above-mentioned share change button 643 to set the share of the payment to be shared by each payment way, and the number-of-month setting field 645 is operated to set the above-mentioned period. When a start button 646 is clicked, the balance simulation is started under the above-mentioned conditions, thereby computing the balance after a predetermined period when each payment way shares each share amount. The result of the balance simulation is displayed on the result display screen.

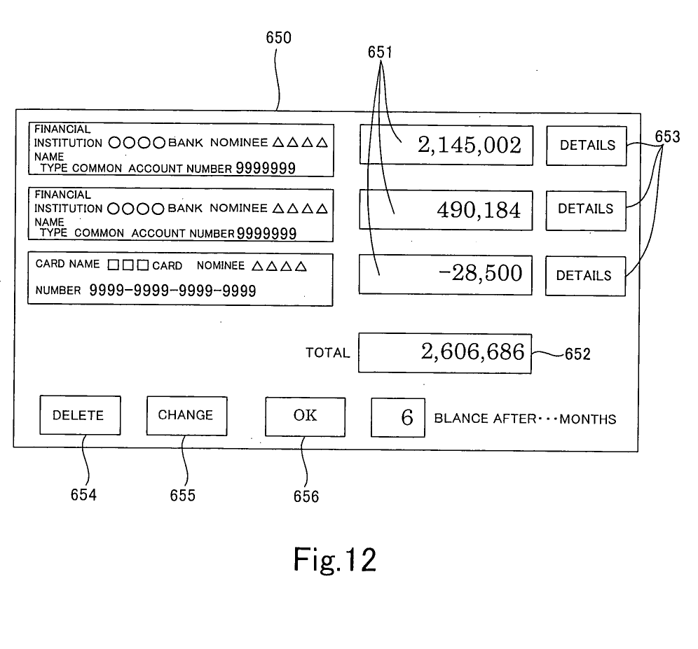

FIG. 12 shows the result display screen.

On a result display screen 650, a balance display field 651 corresponding to each payment way and a total balance display field 652 are provided to display the result of the balance simulation on each balance display field 651, and a total of the balances of the balance display fields 651 is displayed on the total balance display field 652.

On the result display screen 650, a detailed display button 653 corresponding to each payment way is provided. When the detailed display button 653 is clicked, the obtained information as shown in FIG. 10 is displayed for the corresponding payment way.

When a delete button 654 on the result display screen 650 is clicked, the simulation is deleted, and the above-mentioned designation screen 640 is displayed again with the initial value set. When a change button 655 on the result display screen 650 is clicked, the designation screen 640 is displayed again with the simulation set so that the setting can be changed and the simulation section 130 can perform a simulation again. Furthermore, when a purchaser is satisfied with the result of a simulation and determines that payment can be made with the share set by the simulation, an OK button 656 is clicked on the result display screen 650, the determination contents are transmitted to the payment share section 140 shown in FIG. 3, and then the payment is made depending on the determination contents.

Thus, according to the simulation explained by referring to FIGS. 11 and 12, the purchaser, etc. can confirm the balance, etc. with the service point to be obtained taken into account prior to the payment. Therefore, the confirmed contents can be used by a purchaser, etc. in determining the share preferable for the purchaser.

In the present embodiment, payment is made after determining the payment share in the above-mentioned procedure. However, although there is a sufficient balance at the time when the payment share is determined, there can be a deficit balance when the transfer is actually performed. When such a deficit balance occurs, the following countermeasures are taken.

As the countermeasure having the first priority, when a client registers multiple financial institutions as payment way, and when another payment way has a sufficient balance, the balance can be reserved by performing a transferring process between the financial institutions. When the deficit cannot be covered by one payment way, the transfer can be performed from multiple payment way.

As the countermeasure having the second priority, when a purchaser, etc. sets in advance an automatic application of a loan system for deficit balance, the loan system is applied. However, the loan system is not applied if the new application of a loan invites the total amount of loan exceeding the maximum amount of loan.

If there is still a deficit balance after using the above-mentioned countermeasures, the purchaser is prompted by the electronic mail to input the deficit amount of money.

If there occurs the deficit balance for a month, the payment can be extended for a month (the interest for the period is to be paid). The point can be accumulated depending on the used amount every month so that the problem of the deficit can be solved using the point in case of a deficit balance. In this case, it is convenient to set the point accumulation to be easily confirmed.

The explanation of the first embodiment is completed, and the second embodiment of the present invention will be described below. In the second embodiment, the “buying side” does not designate the practical amount of rate when a purchaser buys goods or services, but substantially the same embodiment as the first embodiment can be realized except that a payment share rule is designated by the “buying side.”

The second embodiment of the present invention is also realized in the computer network 10 shown in FIG. 1. The server machine 100 operates as the second embodiment of the payment apparatus according to the present invention by the second embodiment of the payment program of the present invention installed in the hard disk of the server machine 100 and activated, and the computer network 10 having the server machine 100 and the client machines 200 and 300 operates as the second embodiment of the payment system according to the present invention.

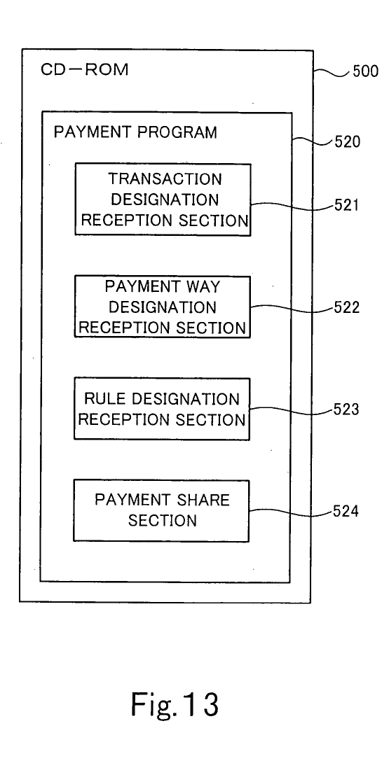

FIG. 13 shows the second embodiment of the payment program according to the present invention. A payment program 520 is stored in the CD-ROM 500.

The payment program 520 is executed in the server machine 100 shown in FIG. 1 to operate the server machine 100 as the second embodiment of the payment apparatus of the present invention, and has a transaction designation reception section 521, a payment way designation reception section 522, a rule designation reception section 523, and a payment share section 524. Each element of the payment program 510 will be described later.

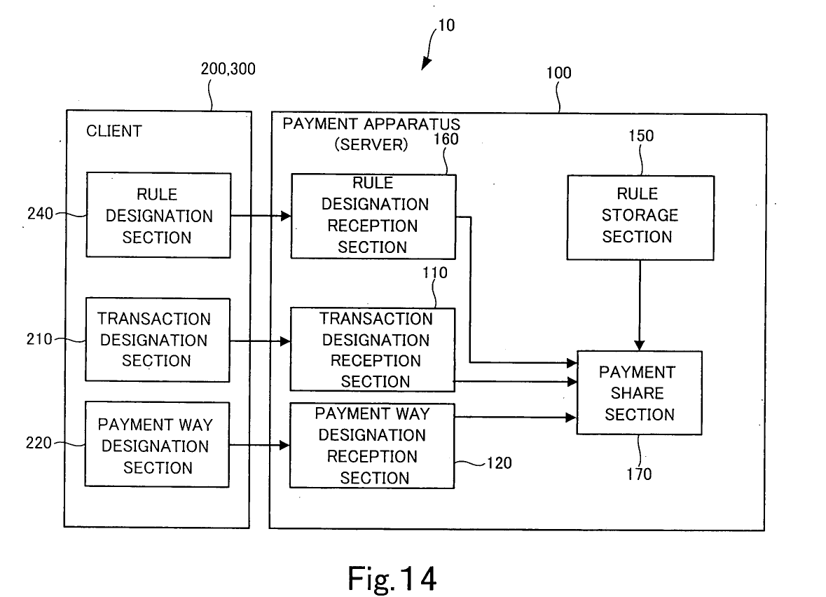

FIG. 14 is a functional block diagram according to the second embodiment of the payment system and the payment apparatus.

The functional block diagram also shows the computer network 10, the server machine 100, the client machines 200 and 300.

In the server machine 100 shown in FIG. 14, the payment program 520 shown in FIG. 13 is installed and executed. Thus, the second embodiment of the payment apparatus of the present invention is configured in the server machine 100, and the second embodiment of the payment system of the present invention is configured in the computer network 10.

The second embodiment of the payment apparatus has the transaction designation reception section 110, the payment way designation reception section 120, a rule storage section 150, a rule designation reception section 160, and a payment share section 170. Among them, the transaction designation reception section 110, the payment way designation reception section 120, the rule designation reception section 160, and the payment share section 170 respectively correspond to the transaction designation reception section 521, the payment way designation reception section 522, the rule designation reception section 523, and the payment share section 524 forming the payment program 520 shown in FIG. 13. However, each element shown in FIG. 14 is configured by a combination of the hardware of the server machine 100 and the OS and the application program executed by the server machine 100 while each element of the payment program shown in FIG. 13 is configured only by the application program.

By accessing the transaction designation reception section 110, the payment way designation reception section 120, and the rule designation reception section 160, the client machines 200 and 300 operate as the terminals having the transaction designation section 210, the payment way designation section 220, and a rule designation section 240.

Each of the elements of the payment program 520 shown in FIG. 13 is explained by explaining each of the payment system and the payment apparatus shown in FIG. 14.

The outline of each of the elements is explained first.

In the present embodiment, the client machines 200 and 300 are operated by the purchaser who purchases goods and services in the Internet shopping.

The transaction designation section 210 and the payment way designation section 220 of the client machines 200 and 300, and the transaction designation reception section 110 and the payment way designation reception section 120 of the server machine 100 are respectively the same as the transaction designation section 210, the payment way designation section 220, the transaction designation reception section 110, and the payment way designation reception section 120 according to the first embodiment, and the explanation is omitted here.

The rule storage section 150 of the server machine 100 stores multiple share rules for sharing the payment among multiple payment way. Therefore, the rule designation section 240 of the client machines 200 and 300 designates the share rule desired by the purchaser in the multiple share rules depending on the operation of the purchaser. The rule designation reception section 160 of the server machine 100 receives the designation of a share rule by the rule designation section 240.

The payment share section 170 of the server machine 100 shares the payment among multiple payment way according to the share rule received by the rule designation reception section 160 in the share rule stored in the rule storage section 150.

In this payment system and payment apparatus, a purchaser, etc. can be free of the trouble of setting the amount for each transaction. Additionally, an operator, etc. of a payment system prepares a convenient share rule for a purchaser, thereby improving the convenience with troublesome operations of the purchaser, etc. reduced.

Described below are the details of the operations of the payment system and the payment apparatus. In the following explanation, for convenience in explanation, the payment system and the payment apparatus are described with the seller of the goods and services assumed to directly operate them.

In the second embodiment, the purchaser (buying side) registers the account, etc. of the payment way to be possibly used in making payment in the payment apparatus and the payment system (selling side). The explanation for details is omitted here to avoid overlapping explanation.

In the second embodiment as in the first embodiment, the seller (selling side) of goods and services provides goods information for a number of unspecified clients. The “buying side” determines desired goods, etc. from among the goods or services provided by the “selling side”, calls by the transaction designation section 210 the dedicated page in the transaction designation reception section 110 shown in FIG. 3 prepared by the “selling side”, and presents the desired goods, etc. to the “selling side”. By the presentation of the goods, etc., the transaction is designated and the procedure of making payment is started.

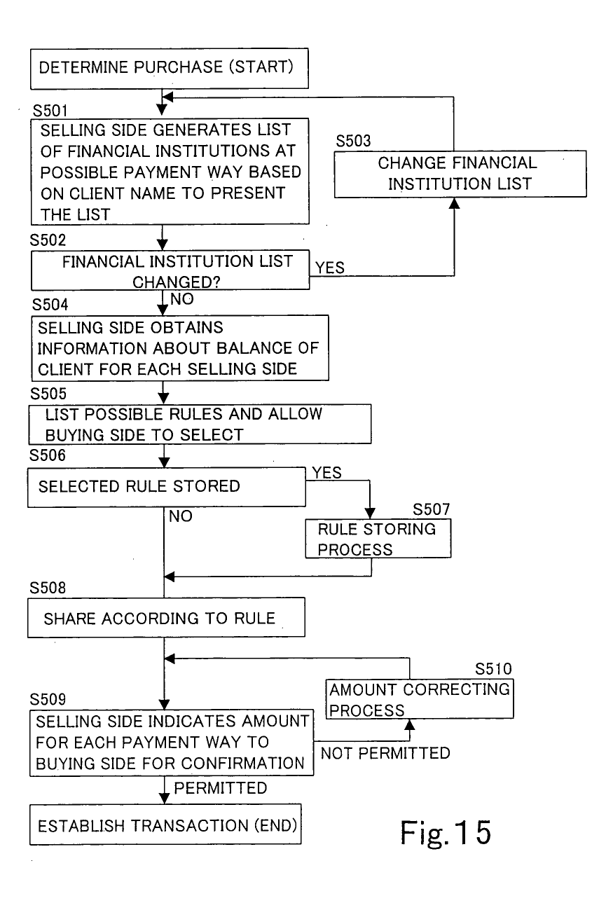

FIG. 15 is a flowchart showing the procedure of making payment according to the second embodiment of the present invention.

The procedure in steps S501 to S504 shown in FIG. 15 is the same as the procedure in steps S201 to S204. Therefore, the overlapping explanation is omitted here.

In the procedure shown in FIG. 15, multiple share rules stored in the rule storage section 150 shown in FIG. 14 are transmitted to the rule designation section 240 through the rule designation reception section 160, and the multiple share rules are displayed by the rule designation section 240 on the share rule selection screen, thereby requesting the “buying side” to select the share rule.

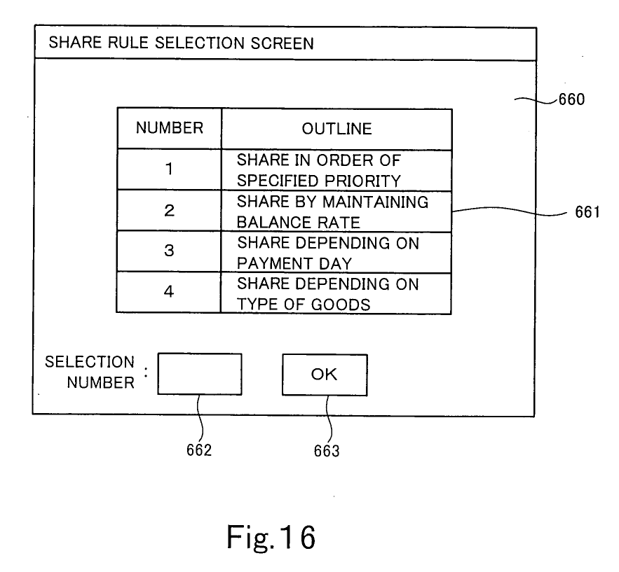

FIG. 16 shows the share rule selection screen.

A share rule selection screen 660 has a share rule display field 661, and the share rule display field 661 displays the number for identification of each share rule and the outline of the share rule. The share rule selection screen 660 also has a selection number input field 662 and an OK button 663 so that a purchaser can select a desired share rule from among the share rules displayed on the share rule display field 661 and input the number of the share rule in the selection number input field 662. By the purchaser clicking the OK button 663, the selected share rule is transmitted from the rule designation section 240 shown in FIG. 14 to the payment share section 170 through the rule designation reception section 160.

As share rules for sharing the payment among multiple payment way, four share rules are shown in FIG. 16.

The first share rule is to set in advance the priority among payment way, share the payment amount based on the priority when making payment, and share the payment amount with the payment way of the next priority when the share of the payment way of the higher priority reaches the balance or the predetermined maximum value. In the share rule, for example, the share is arranged such that the payment is made when the balance reaches zero in the priority order of “transfer from the account 2 in the bank B” after “transfer from the account 1 in the bank A”.

The second share rule is to maintain a constant rate of the balances among the payment way. For example, the share is arranged such that “the payment amount is shared between the balance of the account 1 in the Bank A and the balance of the account 2 in the Bank B in the ratio of 6 to 4”.

The third share rule is to share the payment among the payment way at a share rate depending on the payment day. Based on this share rule, for example, the share is arranged such that “when the transfer date is 1st to 5th, each of the account 1 in the Bank A and the account 2 in the Bank B shares 50%, and, in other period, the account 2 in the Bank B shares 10% and the account 1 in the Bank A is set as a supplementary account”.

The fourth share rule is to share the payment among payment way at a share rate depending on the type of purchased goods. The share rule is, for example, conveniently used when various goods are purchased in a shopping mall over a network in which various shops are registered. With this share rule, for example, the share is arranged such that “the payment for foods is made 100% using the account 1 in the Bank A, and the deficit amount is paid using the supplementary account which is the account 2 in the Bank B. The payment for apparel is made 50% each by using the account 2 in the Bank B, and by the credit card company C”.

As for the share rules, there are a share rule in which payment way is set beforehand and a share rule in which no payment way is set beforehand. When the share rule in which payment way is set beforehand is applied, the payment way is automatically designated when the share rule is selected. However, when the share rule in which no payment way is set beforehand, payment way is designated after the share rule is selected.

The rule storage section 150 shown in FIG. 14 stores these share rules as rule data in the format as shown below.

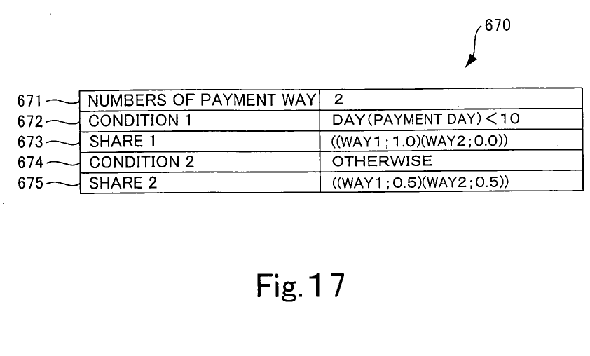

FIG. 17 shows the rule data under the share rule based on the payment day.

Rule data 670 has: the number 671 of payment way indicating the number of payment way for use in payment; a first condition 672 indicating the condition of the payment day to which the payment share is applied; the first share 673 indicating the payment share applied under the condition of the first condition 672; the second condition 674 indicating other condition of the payment day to which the payment share is applied; and the second share 675 showing the payment share applied under the condition indicated by the second condition 674.

The rule data 670 shown in FIG. 17 practically indicates the following. That is, two payment ways are used. Under the first condition of “value for the day in the payment day is less than 10”, “the share rate of the first payment way is 10%, and the share rate of the second payment way is 0%”. Under the second condition of “other payment days”, “the share rate of the first payment way is 50%, and the share rate of the second payment way is also 50%”.

The rule data 670 can be generated in the payment apparatus and stored by a purchaser or a manager of the payment system setting a share rule in the procedure explained below.

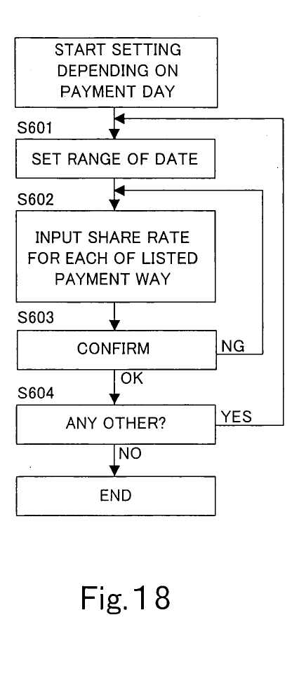

FIG. 18 is a flowchart of the setting procedure of a share rule based on the payment day.

When the setting procedure of the share rule is started, a range of a payment day is set by a month and a day (step S601), and the share rate for payment is input for each financial institution registered as payment way (step S602) The input share rate is confirmed (step S603). If there is an error in the share rate, control is returned to step S602.

When it is determined that the share rate is correct in step S603, it is asked whether or not another range of the payment day is set (step S604). If another range is set, control is returned to step S601. If another range is not set, the setting procedure terminates.

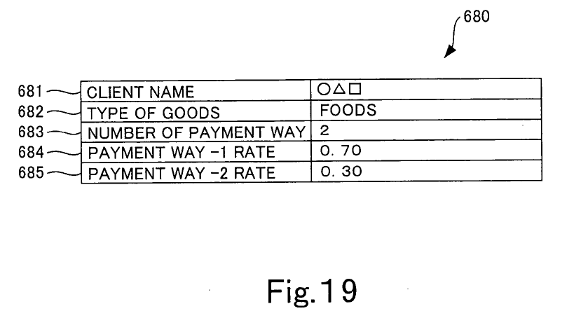

FIG. 19 shows the rule data for the fourth share rule described above.

A rule data 680 is registered in advance by the purchaser, and includes a purchaser name 681 of the purchaser (that is, a client). The rule data 680 has a goods type name 682 of the goods to be a target of payment share under the share rule, the number 683 of payment way, the share rate 684 of the payment by the first payment way, and the share rate 685 of the payment by the second payment way.

For example, the rule data 680 shown in FIG. 19 has the following meaning. That is, the “foods” purchased by the client (purchaser) having the name of “◯Δ□” are shared by two payment way in making payment. The first payment way shares 0.70, and the second payment way shares 0.30.

Back in FIG. 15, the explanation is given below.

In step S505, when a share rule is selected and designated on the share rule selection screen, it is confirmed by the “buying side” whether or not the selected share rule is stored (step S506). If the “buying side” requests to store it, the share rule is stored (step S507) The stored share rule is, for example, used as reference in making payment next time.

Afterwards, the payment amount is shared according to the selected share rule (step S508). The procedure of sharing the payment amount is explained by using, as an example, the share rule for payment share among payment way at a share rate depending on the type of purchased goods as shown as the fourth share rule on the share rule selection screen 660 in FIG. 16.

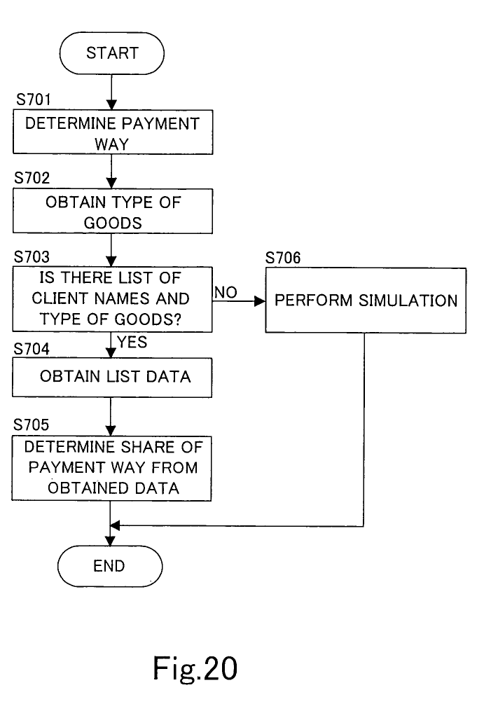

FIG. 20 is a flowchart of the procedure of sharing a payment amount according to the share rule depending on the type of goods.

In the procedure shown in FIG. 20, first, the payment way for use in the current payment is determined by the “buying side” from among the payment way registered in the payment system (step S701). Then, the type of purchased goods are obtained from the information when the site of the network shop selling the goods and the shop are registered in the system (step S702), and it is determined whether or not there is rule data 680 as shown in FIG. 19 registered by the purchaser for the type of obtained goods (step S703). If it is determined that there is rule data, then the rule data is obtained (step S704). According to the rule data, the amount to be shared by each payment way is determined (step S705), thereby terminating the procedure.

If it is determined that there are no corresponding rule data in step S703, then the simulation similar to that in the first embodiment is performed, and an initial value of a share of each payment way is determined, thereby terminating the procedure (step S706).

If various types of goods are processed in one transaction, the steps in and after S702 are repeated, the payment amount is shared for each type of goods, thereby sharing the payment amount in a transaction.

Back in FIG. 15, the explanation is given below.

As explained above, after the payment amount is shared, the “selling side” confirms with the “buying side” for the payment share (step S509). When the payment share is not permitted, the amount correcting process is performed by correcting the share of the payment amount at an instruction of the “buying side” (step S510), and the payment share is confirmed again (step S509). When the payment share is permitted, the “selling side” checks whether the payment share determined by the “buying side” is valid. If yes, the transaction is established at this time point, and the procedure shown in FIG. 15 terminates. Since the procedure after the establishment of the transaction in the second embodiment is quite the same as that according to the first embodiment, the explanation is omitted here to avoid duplicate explanation.

As described below, according to the payment system and the payment apparatus of the present invention, multiple payment way can be used in making payment in one shopping. Therefore, a payment method with high flexibility can be provided. Since the payment system and the payment apparatus can be used, the shop in the online shopping and the use opportunity of credit shopping, etc. can be greatly expanded.

In the above-mentioned explanation, a payment system and a payment apparatus for the Internet shopping are shown as examples, but the payment system and the payment apparatus can be applied to those used in shopping using a card but cash in an ordinary shop.

Also in the explanation above, the payment system and the payment apparatus are used as being operated by a seller of goods and services, but the payment system and the payment apparatus according to the present invention can be operated by a manager who provides a shopping mall over the Internet for sellers and purchasers.

Furthermore, in the explanation above, the priority assigned to the payment way by the simulation section is used only in setting the initial value of sharing. However, in the payment system and the payment apparatus according to the present invention, the priority can be presented to the purchaser, etc. for use as reference in determining a share.

1. A payment system, comprising:
a transaction designation section which designates a transaction to be settled depending on an operation;
a payment way designation section which designates payment way for making payment for a transaction depending on an operation and which is capable of designating a plurality of payment way for each transaction; and
a payment share section which allows a plurality of payment way designated by the payment way designation section to share payment for a transaction designated by the transaction designation section.

2. The payment system according to claim 1, wherein the payment share section allows the plurality of payment way to share the payment based on setting in which at least one of an amount or a rate is set in each of the plurality of payment way.

3. The payment system according to claim 1, further comprising a rule storage section which stores a rule for dividing a payment into a plurality of payment way, wherein the payment share section divides a payment according to the rule stored in the rule storage section, and the divided payment is shared among the plurality of payment way.

4. The payment system according to claim 3, wherein the rule storage section stores the plurality of rules, and
wherein the payment share section is assigned one of the rules stored in the rule storage section, shares the payment according to the designated rule, and allows a plurality of payment way to share the assigned payment.

5. The payment system according to claim 1, further comprising a simulation section which simulates a payment result of a transaction for payment way designated by the payment way designation section.

6. The payment system according to claim 5, wherein the simulation section assigns a priority to the plurality of payment way based on the payment result obtained from the simulation.

7. A payment apparatus, comprising:
a transaction designation reception section which receives designation of a transaction over a communications network;
a payment way designation reception section which receives designation of payment way for making payment for a transaction over a communications network and which is capable of receiving designation of a plurality of payment way for one transaction; and
a payment share section which allows a plurality of payment way whose designation is received by the payment way designation reception section to share the payment of the transaction whose designation is received by the transaction designation reception section.

8. The payment apparatus according to claim 7, wherein the payment share section allows the plurality of payment way to share the payment based on setting in which at least one of an amount and a rate is set in each of the plurality of payment way.

9. The payment apparatus according to claim 7, further comprising a rule storage section which stores a rule for dividing a payment into a plurality of payment way, wherein the payment share section divides a payment according to the rule stored in the rule storage section, and the divided payment is shared among the plurality of payment way.

10. The payment apparatus according to claim 9, wherein the rule storage section stores a plurality of rules, and
wherein the payment share section is assigned one of the rules stored in the rule storage section, shares the payment according to the designated rule, and allows a plurality of payment way to share the assigned payment.

11. The payment apparatus according to claim 7, further comprising a simulation section which simulates a payment result of a transaction for payment way designated by the payment way designation section.

12. The payment apparatus according to claim 11, wherein the simulation section assigns a priority to the plurality of payment way based on the payment result obtained from the simulation.

13. (cancelled)

14. A payment program storage medium storing a payment program, comprising:
a transaction designation reception section which receives designation of a transaction over a communications network;
a payment way designation reception section which receives designation of payment way for making payment for a transaction over a communications network and which is capable of receiving designation of a plurality of payment way for one transaction; and
a payment share section which allows a plurality of payment way whose designation is received by the payment way designation reception section to share the payment of the transaction whose designation is received by the transaction designation reception section.
